(19) United States
(12) Patent Application Publication
(10) Pub. No.: US 2026/0339725 A1
(43) Pub. Date: Oct. 29, 2026

(54) TASK PERFORMANCE USING A MACHINE LEARNING AGENT-GENERATED ACTION

(71) Applicant: ADOBE INC., SAN JOSE, CA (US)

(72) Inventors: Dang Minh Nguyen, College Park, MD (US); Viet Dac Lai, Eugene, OR (US); Seunghyun Yoon, San Jose, CA (US); Ryan A. Rossi, San Jose, CA (US); Handong Zhao, Cupertino, CA (US); Ruiyi Zhang, Mountain View, CA (US); Puneet Mathur, Sunnyvale, CA (US); Nedim Lipka, Campbell, CA (US); Trung Huu Bui, San Jose, CA (US); Franck Dernoncourt, Seattle, WA (US)

(21) Appl. No.: 19/192,775

(22) Filed: Apr. 29, 2025

(51) Int. Cl. G06F 9/50

(52) U.S. Cl. CPC G06F 9/5027

(57) ABSTRACT

A method, apparatus, non-transitory computer readable medium, and system for data processing includes receiving a task, determining that an action set of the machine learning agent is inadequate for performing the task, generating a new action for the action set, wherein the new action comprises software code for performing the task, and executing the new action to perform the task.

### BACKGROUND

The following relates generally to machine learning, and more specifically to task performance using a machine learning agent-generated action. Machine learning is a field of study in artificial intelligence concerned with the development and study of statistical algorithms, such as artificial neural networks, that can learn from data and generalize to unseen data, and thus perform tasks without explicit instructions.

Some data processing systems leverage a machine learning agent (typically a large language model (LLM) agent) to process a natural language input describing a task, make a decision about an action to be performed with respect to the task, and generate an output given the task and the decision. However, existing machine learning agents are constrained to operate by retrieving one or more actions from a predefined action set, and are therefore unable to accurately complete a task for which the predefined action set is inadequate.

### SUMMARY

Systems and methods are described for task performance using a machine learning agent-generated action. In some embodiments, a machine learning agent of a data processing system receives a task and determines that a predefined action set for the machine learning agent is inadequate for performing the task. In response to the determination, the machine learning agent generates a new task for the action set. The data processing system executes the new action to perform the task.

Because the machine learning agent is able to determine that the action set is inadequate, and to generate the new action based on the determination, the data processing system is able to successfully perform the task. By contrast, existing machine learning agents are unable to generate new actions, and therefore existing data processing systems are unable to employ existing machine learning agents to perform tasks that would benefit from a generation of new actions.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The Detailed Description is described with reference to the accompanying figures. Entities represented in the figures are indicative of one or more entities and thus reference is made interchangeably to single or plural forms of the entities in the discussion.

FIG. 1 shows an example of a data processing system according to aspects of the present disclosure.

FIG. 2 shows an example of a method for performing a task using a new action according to aspects of the present disclosure.

FIG. 3 shows an example of a machine learning agent framework according to aspects of the present disclosure.

FIG. 4 shows an example of a first portion of a machine learning agent prompt according to aspects of the present disclosure.

FIG. 5 shows an example of a second portion of the machine learning agent prompt described with reference to FIG. 4.

FIG. 6 shows an example of a table of a set of functions according to aspects of the present disclosure.

FIG. 7 shows an example of an unsuccessful execution of a predefined action according to aspects of the present disclosure.

FIG. 8 shows an example of a successful execution of a new action according to aspects of the present disclosure.

FIG. 9 shows an example of a transformer according to aspects of the present disclosure.

FIG. 10 shows an example of a method for generating and executing a new action to perform a task according to aspects of the present disclosure.

FIG. 11 shows an example a flow diagram depicting a procedure for performing a task according to aspects of the present disclosure

FIG. 12 shows an example of a flow diagram depicting a procedure for evaluating an observation according to aspects of the present disclosure.

FIG. 13 shows an example of a method for executing a new action generated based on an action plan according to aspects of the present disclosure.

FIG. 14 shows an example of a flow diagram depicting an algorithm as a step-by-step procedure for training a machine learning model according to aspects of the present disclosure.

FIG. 15 shows an example of a computing device according to aspects of the present disclosure.

FIG. 16 shows an example of a data processing apparatus according to aspects of the present disclosure.

### DETAILED DESCRIPTION

### Overview

In machine learning, an agent is an entity that interacts with an environment to make decisions and take actions to achieve a specific goal. The agent receives inputs from the environment, processes the inputs using a decision-making model (often based on machine learning algorithms), and then performs actions that influence the environment.

Reinforcement learning has achieved success in training an agent to perform a task in specific domains via feedback in the form of rewards or penalties to increase a performance of the agent over time, but reinforcement learning cannot train an agent for adaptability and generalization within dynamic and uncertain environments. Large language models (LLMs) have alternatively been implemented as agents for solving complex, real-world problems due to their strong reasoning ability and parametric knowledge gained during training.

However, existing LLM agents are constrained to select an action from a predefined action set (i.e., an action set including actions that are defined prior to performing a task). Therefore, existing LLM agents do not have the flexibility to perform actions outside of a predefined scope, and existing LLM agent systems accordingly cannot perform novel tasks that require new actions.

Furthermore, existing LLM agent systems require significant human effort to carefully enumerate and implement all possible actions within an action set for the LLM agent beforehand, which is prohibitively expensive and impractical when determining an action set that can be used for accomplishing tasks in real-world settings. Finally, in long-horizon tasks, existing LLM agents must compose sequences of primitive actions from scratch at each decision point, which limits the ability of the existing LLM agents to learn from past experiences and to increase efficiency over time.

By contrast, aspects of the present disclosure provide a data processing system and methods that enable a dynamic creation and composition of actions in an online manner using an agent-environment framework. According to some aspects, a machine learning agent of the data processing system generates an action for an action set (e.g., an executable program written in a general-purpose programming language) for performing a task in response to determining that the action set does not include an action that can be used to perform the task. An environment of the data processing system, such as a software interpreter, executes the generated action to perform the task. Furthermore, in some embodiments, generated actions are accumulated over time for future reuse by the machine learning agent.

Because the machine learning agent is able to generate the new action based on a determination that the predefined action set is inadequate for performing the task, the data processing system is able to successfully perform the task. By contrast, existing machine learning agents are unable to generate new actions, and therefore existing data processing systems are unable to employ existing machine learning agents to perform tasks that require a generation of new actions.

Furthermore, according to some aspects, the machine learning agent is not fine-tuned to determine that an action set of the machine learning agent is inadequate for performing the task and to generate a new action for the action set. The data processing system is therefore more efficient and less computationally expensive than systems which rely on using training methods such as reinforcement learning to train an agent to act within an environment.

Benchmarking experiments demonstrate that the data processing system provides significantly greater flexibility and performance than existing machine learning agent systems and methods. Notably, the ability of the machine learning agent to generate new actions allows the data processing system to recover in scenarios in which no relevant action exists in a predefined action set or when existing actions fail due to unforeseen edge cases.

### Terminology Examples

A “task” comprises an instruction to a data processing system to accomplish an objective or to solve a problem. In some embodiments, a task includes a text string including the instruction. In some embodiments, a task includes a document, such as a text file, an audio file, an image file, a video file, a multi-media file, or other information such as a hyperlink to a website, a file, etc. In some embodiments, the instruction refers to the document. In some embodiments, the task is provided as an input to a machine learning agent.

A “machine learning agent” comprises a machine learning model that is capable of generating an action. In some embodiments, the machine learning model comprises a language generation model, such as an LLM, that is trained to output text based on an input. In some embodiments, the language generation model comprises a transformer. In some embodiments, the language generation model comprises a decoder-only language model.

An “action” includes executable software code in a programming language, such as a high-level programming language that is designed to be readable and understandable by humans. An “action set” is a set of one or more actions. An action may be “inadequate” because the action is not capable of returning information that is useful for performing a task.

In some embodiments, a “new action” is an action that includes code that is not included in the action set. In some embodiments, a new action includes code that defines a software function that is not defined in an action included in the action set. A “software function”, or a “function”, is a reusable and executable block of code which takes an input argument, process the argument, and returns an output when executed.

An action may be executed within an environment by a “software interpreter.” A software interpreter is a program that executes code line by line, translating high-level programming language instructions into machine code or an intermediate representation in real time. Unlike compilers, which convert an entire program into executable code before running it, an interpreter processes code incrementally, allowing for immediate execution and debugging. In some embodiments, the software interpreter comprises a programming-language specific backend, such as a kernel, that is designed for interactivity between the software interpreter and an external source, such as an external function or system, and the software interpreter interacts with the external source via the backend.

An “environment” is an external system or external context in which the machine learning agent operates, interacts, and learns. The environment defines the surroundings, conditions, and constraints within which the machine learning agent makes observations, takes actions, and receives feedback.

An “action plan”, or a “thought”, comprises a text output of the machine learning agent that indicates a reasoning about an action to be generated at a given time step in a process of performing a task. The action plan may include an indication of why a new action should be generated. The action plan may include an indication of why the action set is inadequate for performing the task.

A “prompt” comprises a text instruction to the machine learning agent. The prompt may include text describing the intended functionality of the machine learning agent to the machine learning agent, for example, guidelines for generating software code. The prompt may be provided as an input to the machine learning agent. The prompt may be provided independently of the task. The prompt may include the task. The prompt may include all or a portion of the action set.

An “embedding” is a representation of an object in an embedding space such that semantic information about the object is more easily captured and analyzed by a machine learning model. An “embedding space” (or a “vector space”) refers to a mathematical set having embeddings (or vectors) as components, and is characterized by a dimension specifying a number of independent directions in the embedding space.

For example, the embedding is a numerical representation of the object in a continuous vector space in which objects that include similar semantic information to each other correspond to vectors that are numerically similar and thus “closer” to each other, thereby allowing a similarity between different objects corresponding to different embeddings to be readily determined.

An example of the present disclosure is used in a task performance context. In the example, a user tasks the data processing system with moving from one cell of a spreadsheet to another according to particular movement rules, and identifying the color of the cell that should be landed on during the 11^{th} movement turn according to the movement rules.

The machine learning agent of the data processing system generates an action plan for performing the task. The action plan identifies that the existing action set for the machine learning agent does not include an action that can be used for obtaining the colors of the cells of the spreadsheet, and identifies that a new action should be generated instead.

The machine learning agent generates the new action that includes software code defining a new function for identifying the colors of the cells and that takes the spreadsheet as an argument. The data processing system adds the new action to the action set, executes the new action to obtain the colors of the cells, and returns the colors of the cells to the machine learning agent as an observation. The machine learning agent proceeds to perform subsequent iterative steps of generating new actions or retrieving actions from the action set until the information requested in the task is returned. The data processing system then provides the requested information to the user.

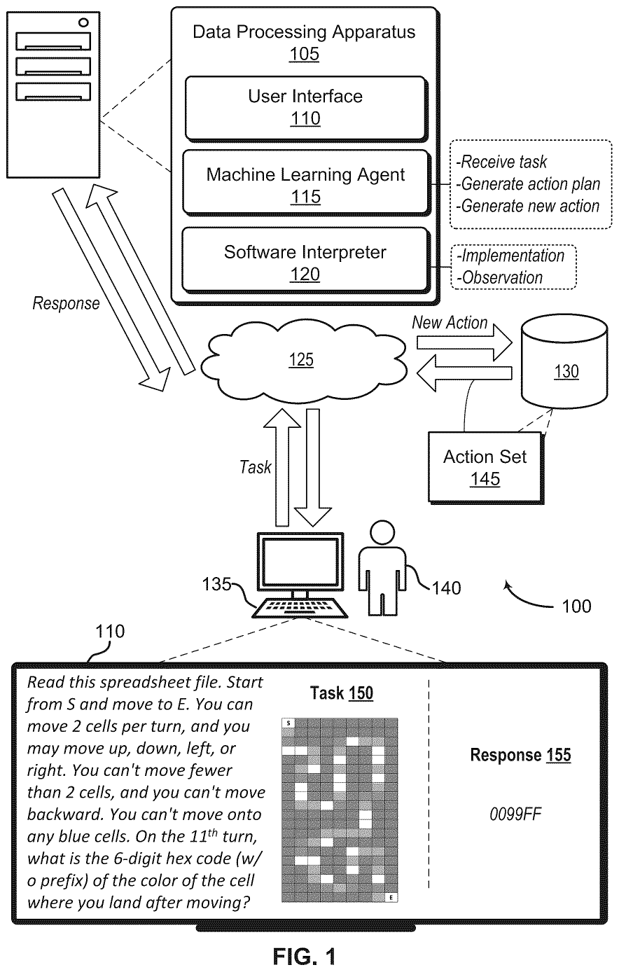

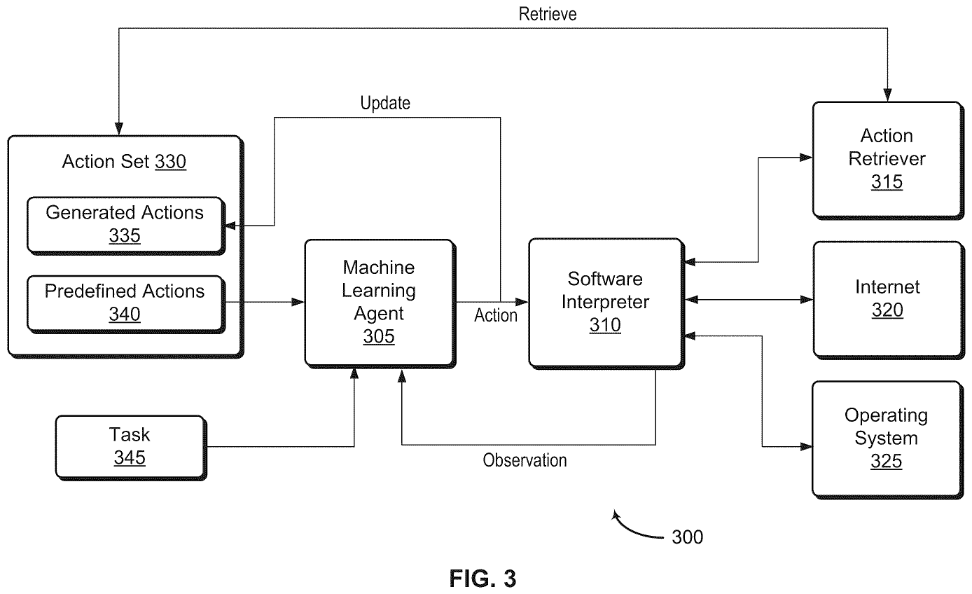

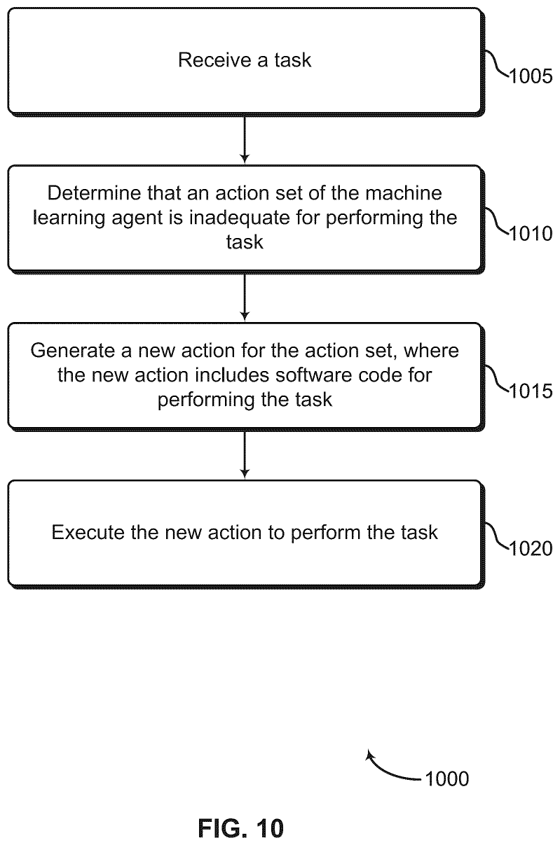

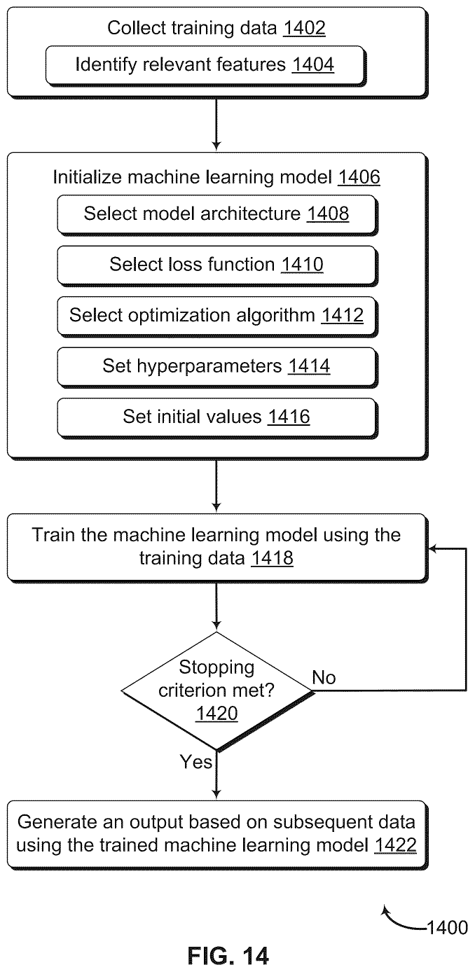

Further examples of the present disclosure in a task performance context are provided with reference to FIGS. 1-2 and 7-8. Details regarding the architecture of the data processing system are provided with reference to FIGS. 3-9 and 15-16. Examples of a processes for performing a task based on a new action is provided with reference to FIGS. 10-13. Examples of a process for training the machine learning agent is provided with reference to FIG. 14.

### Data Processing System

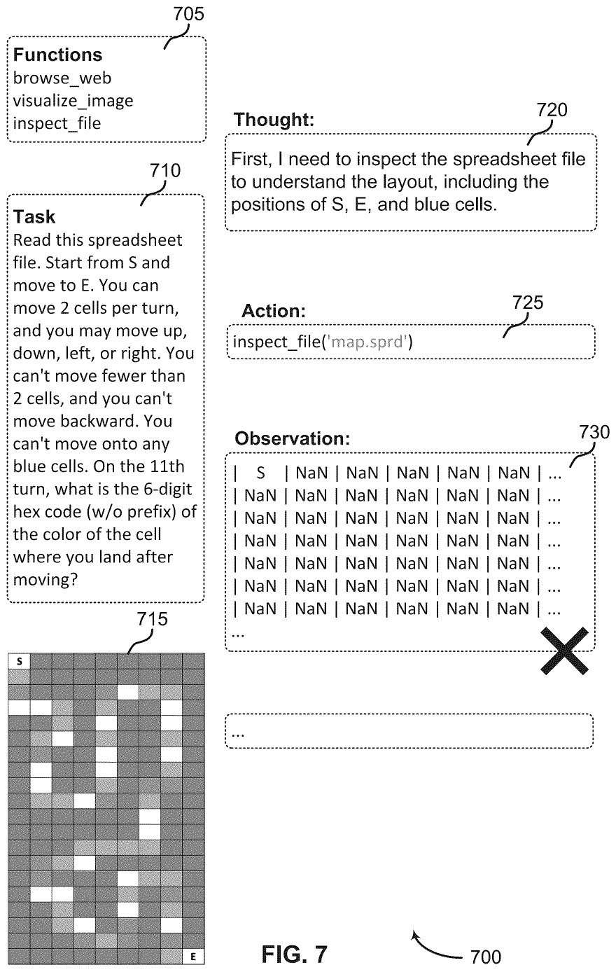

FIG. 1 shows an example of a data processing system 100 according to aspects of the present disclosure. The example shown includes data processing system 100, user device 135, user 140, action set 145, task 150, and response 155. In one aspect, data processing system 100 includes data processing apparatus 105, cloud 125, and database 130. In one aspect, data processing apparatus 105 includes user interface 110, machine learning agent 115, and software interpreter 120. Action set 145 is an example of, or includes aspects of, the corresponding element described with reference to FIG. 3. Task 150 is an example of, or includes aspects of, the corresponding element described with reference to FIGS. 3 and 7.

Referring to FIG. 1, data processing system 100 uses machine learning agent 115 to generate a new action (e.g., executable software code) that machine learning agent 115 determines will contribute to performing an assigned task (e.g., task 150). Because machine learning agent 115 is able to generate new actions, rather than merely selecting from predefined actions, data processing system 100 is able to perform actions to successfully perform tasks that conventional agent systems cannot. In some embodiments, generating a new action comprises generating code defining a new function, where a new function is a function that is not included in an action of an action set.

For example, data processing apparatus 105 receives a task (e.g., task 150) from a user (e.g., user 140) via user interface 110 displayed on a user device (e.g., user device 135). Task 150 includes a spreadsheet including colored cells and an instruction to provide a color of a cell that is landed upon based on an instructed movement pattern. Machine learning agent 115 receives the task and determines that executable code stored in action set 145 is inadequate for performing a current step in a process of performing the task.

In some cases, machine learning agent 115 generates a “thought”, or an action plan, based on the task (and in some cases, based on other variables, such as previously taken actions, and observations received from software interpreter 120). In generating the thought, machine learning agent 115 determines that the current state of responding to the task requires an action to be performed that is not included in action set 145, and so generates a new action (e.g., software code including a function) in response to the determination. Data processing apparatus 105 adds the new action to the action set (for example, by determining that the new action includes text that is not stored in action set 145).

Software interpreter 120 performs the action (e.g., executes the software code) to obtain a result (e.g., an observation). Software interpreter 120 provides the result to machine learning agent 115. Machine learning agent 115 determines based on the result whether the task has been performed. The process of retrieving or generating an action and executing the action continues until machine learning agent 115 determines that the task has been or is able to be performed successfully, machine learning agent 115 determines that the task cannot be performed, or a predetermined number of iterations are completed. Machine learning agent 115 provides a response (e.g., response 155) indicating the end result of the process. Response 155 indicates the requested 6-digit hex code for the requested cell of the spreadsheet, “0099FF”.

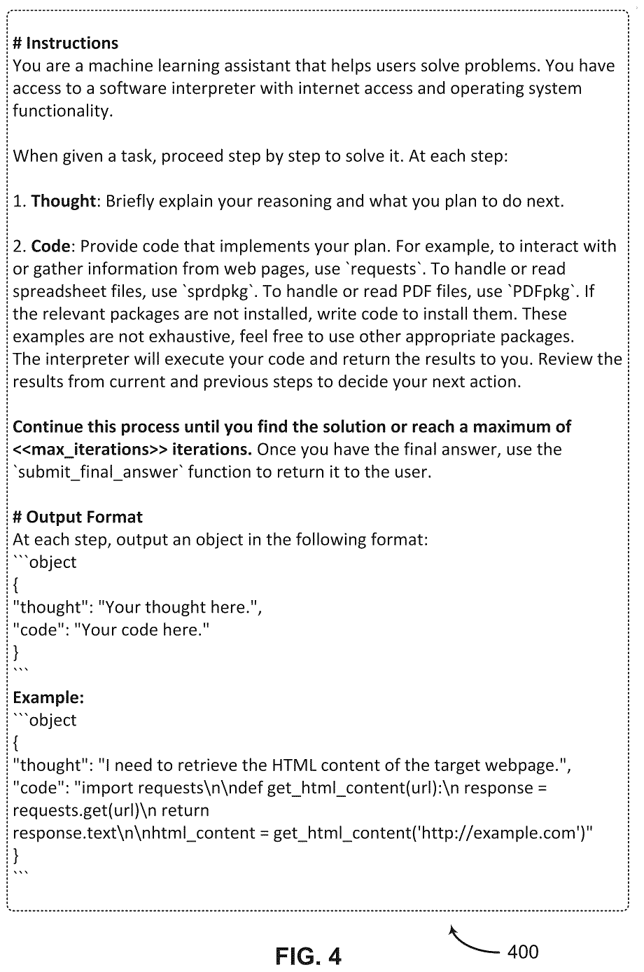

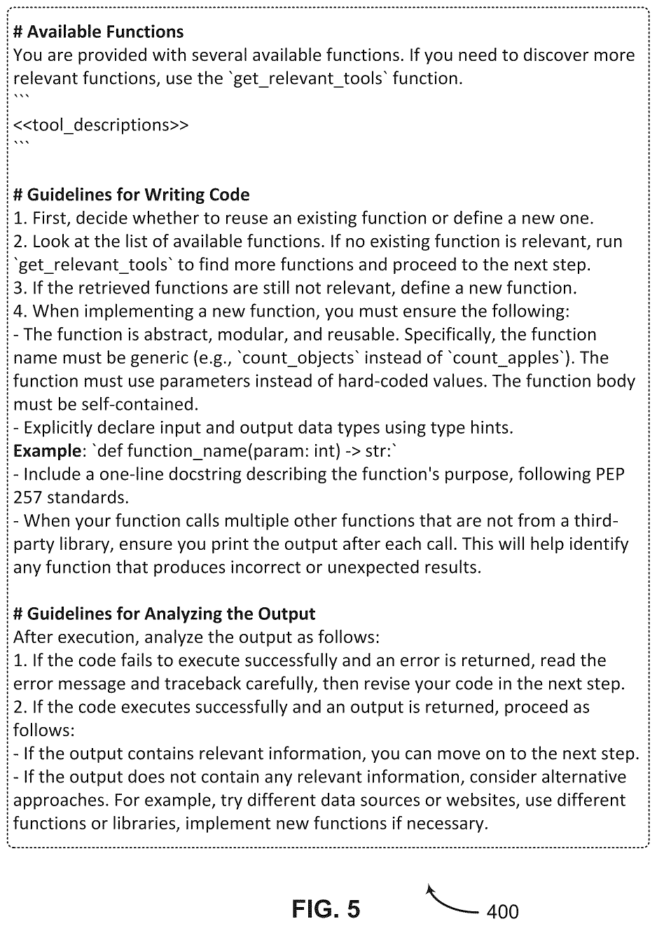

In some embodiments, in response to receiving a task, data processing system 100 provides a prompt to machine learning agent 115, where the prompt includes guidelines for performing the task. An example prompt is described with reference to FIGS. 4 and 5. In some embodiments, at least a portion of action set 145 is included in the prompt. In some embodiments, a portion of action set 145 is included in the prompt and a portion of action set 145 is stored in database 130.

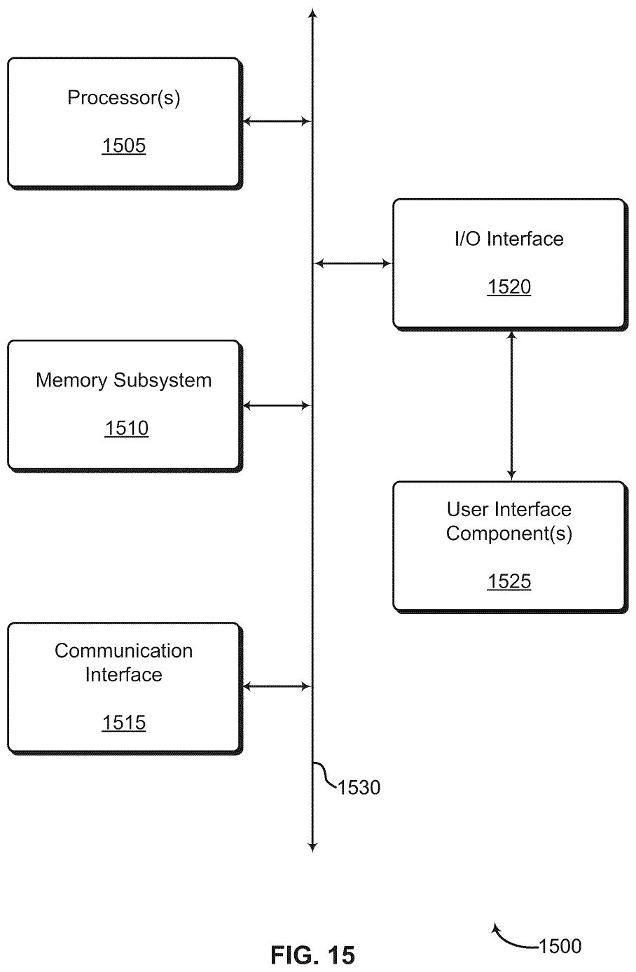

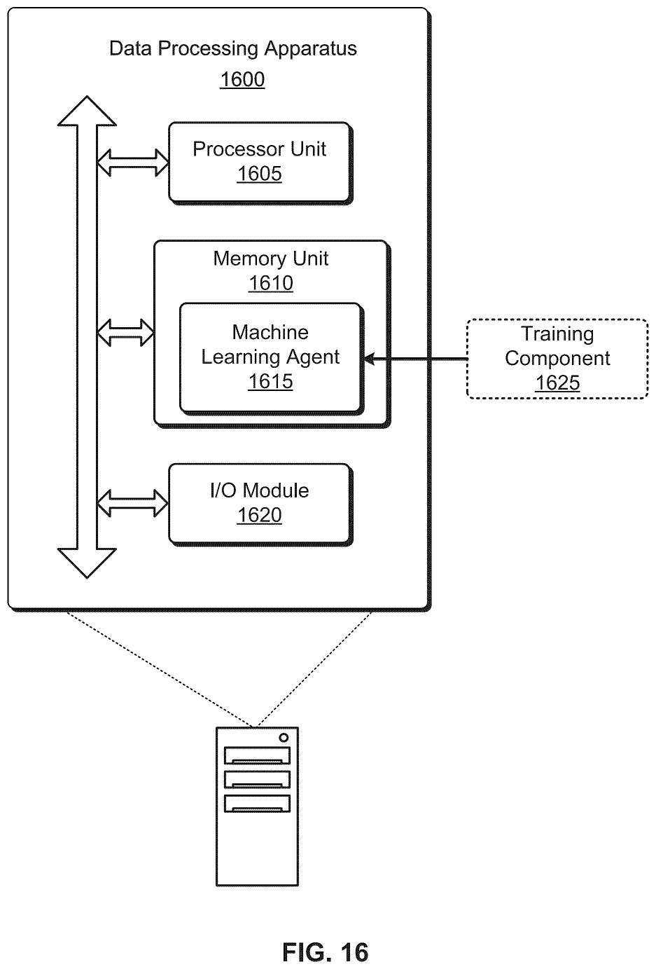

Data processing apparatus 105 is an example of, or includes aspects of, the corresponding element described with reference to FIGS. 15 and 16. According to some aspects, data processing apparatus 105 includes a computer-implemented network. In some embodiments, the computer-implemented network includes machine learning agent 115. Data processing apparatus 105 may also include one or more processors, a memory subsystem, a communication interface, an I/O interface, one or more user interface components, and a bus as described with reference to FIG. 15. Additionally, data processing apparatus 105 may communicate with the user device and database 130 via cloud 125.

According to some aspects, data processing apparatus 105 is implemented on a server. A server provides one or more functions to users linked by way of one or more of various networks, such as cloud 125. The server may include a microprocessor board that includes a microprocessor responsible for controlling all aspects of the server. The server uses the microprocessor and protocols such as hypertext transfer protocol (HTTP), simple mail transfer protocol (SMTP), file transfer protocol (FTP), and simple network management protocol (SNMP) to exchange data with other devices or users on one or more of the networks. The server may be configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

User interface 110 allows information to be communicated between the user and data processing apparatus 105. According to some aspects, user interface 110 comprises a text interface, a graphical user interface, or a combination thereof. According to some aspects, user interface 110 comprises software stored in a memory unit of data processing apparatus 105 (such as the memory unit 1610 described with reference to FIG. 16).

Machine learning agent 115 is an example of, or includes aspects of, the corresponding element described with reference to FIGS. 3 and 16. According to some aspects, machine learning agent 115 comprises machine learning parameters stored in a memory unit of data processing apparatus 105 (such as the memory unit 1610 described with reference to FIG. 16). According to some aspects, machine learning agent 115 comprises an artificial neural network (ANN) that is trained as described with reference to FIG. 14 to generate a text output (e.g., executable software code) based on an input.

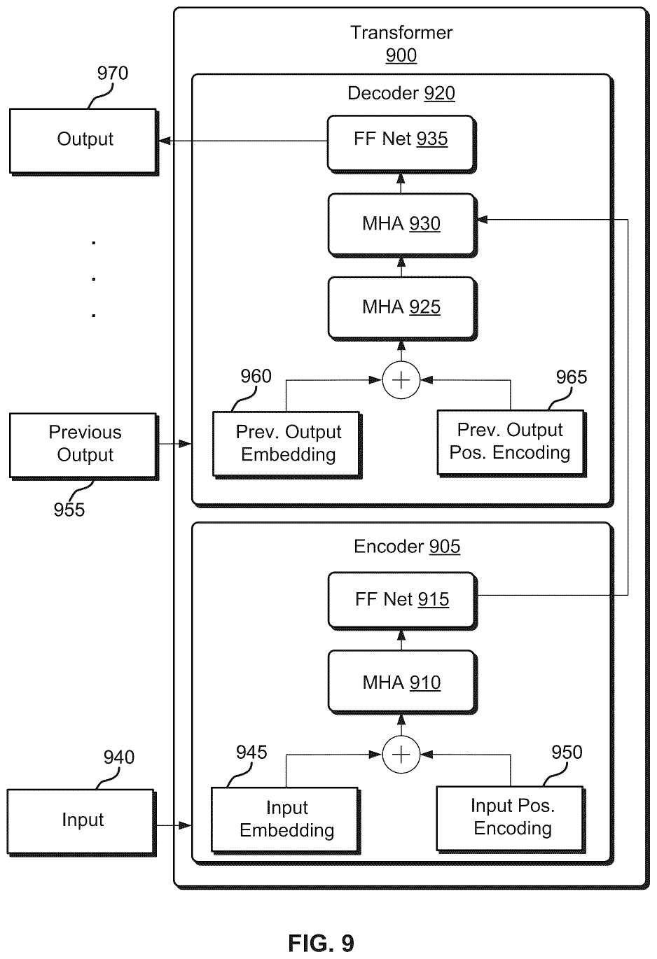

According to some aspects, machine learning agent 115 comprises a language generation model. In some embodiments, the language generation model comprises a transformer, such as the transformer described with reference to FIG. 9. In some cases, a transformer comprises an encoder and a decoder. The encoder takes in input data, such as a sentence, and encodes the input into a set of continuous representations or embeddings. The encoder processes the entire input sequence at once, learning relationships between each of the tokens in the sequence. The decoder takes the encoded information as input and generates an output sequence one token at a time. The decoder attends to previous tokens that the decoder has generated, allowing the decoder to make predictions about a next token in a sequence.

According to some aspects, the language generation model comprises a decoder-only language model. A decoder-only language model, such as a generative pretrained transformer, omits an encoder and performs autoregressive text generation by predicting one output token at a time based on an input sequence of text, where each prediction is conditioned on tokens that the model has already generated. After generating the first token, the decoder-only language model adds the first token to the input and predicts a next token, continuing the process. The decoder uses self-attention to attend to previously generated tokens, helping the decoder-only language model to understand relationships between each of the tokens in the sequence, allowing the decoder-only language model to generate coherent and contextually appropriate text.

Software interpreter 120 is an example of, or includes aspects of, the corresponding element described with reference to FIG. 3. In some embodiments, software interpreter 120 comprises a program that executes software code line by line, translating the software code from a high-level programming language into machine code at runtime, rather than compiling the software code into machine code beforehand, thereby allowing for immediate execution without needing a separate compilation step. In some embodiments, software interpreter 120 comprises executable instructions stored in the memory unit of data processing apparatus 105.

Further detail regarding the architecture of a data processing system are provided with reference to FIGS. 3-9 and 15-16. Further detail regarding a processes for performing a task based on a new action is provided with reference to FIGS. 10-13. Further detail regarding a process for training machine learning agent 115 is provided with reference to FIG. 14.

Cloud 125 is a computer network configured to provide on-demand availability of computer system resources, such as data storage and computing power. In some examples, cloud 125 provides resources without active management by a user. The term “cloud” is sometimes used to describe data centers available to many users over the Internet. Some large cloud networks have functions distributed over multiple locations from central servers. A server is designated an edge server if the server has a direct or close connection to a user. In some examples, cloud 125 is limited to a single organization or be available to many organizations. In one example, cloud 125 includes a multi-layer communications network comprising multiple edge routers and core routers. In another example, cloud 125 is based on a local collection of switches in a single physical location. According to some aspects, cloud 125 provides communications between data processing apparatus 105, database 130, and the user device.

Database 130 is an organized collection of data. In an example, database 130 stores data in a specified format known as a schema. According to some aspects, database 130 is structured as a single database, a distributed database, multiple distributed databases, or an emergency backup database. Data storage and processing in database 130 is manageable by a database controller, which can be operated by a user or automatically without interaction from the user. According to some aspects, database 130 is included in data processing apparatus 105. According to some aspects, database 130 is external to data processing apparatus 105 and communicates with data processing apparatus 105 via cloud 125. In some embodiments, database 130 stores action set 145. In some embodiments, database 130 stores a portion of action set 145. In some embodiments, action set 145 includes an additional action.

According to some aspects, the user device is a personal computer, laptop computer, mainframe computer, palmtop computer, personal assistant, mobile device, or any other suitable processing apparatus. In some examples, the user device includes software that displays user interface 110 provided by data processing apparatus 105.

According to some aspects, a user device user interface enables a user to interact with the user device. In some embodiments, the user device user interface includes an audio device, such as an external speaker system, an external display device such as a display screen, or an input device (e.g., a remote-control device interfaced with the user interface directly or through an I/O controller module). In some cases, the user device user interface is a graphical user interface.

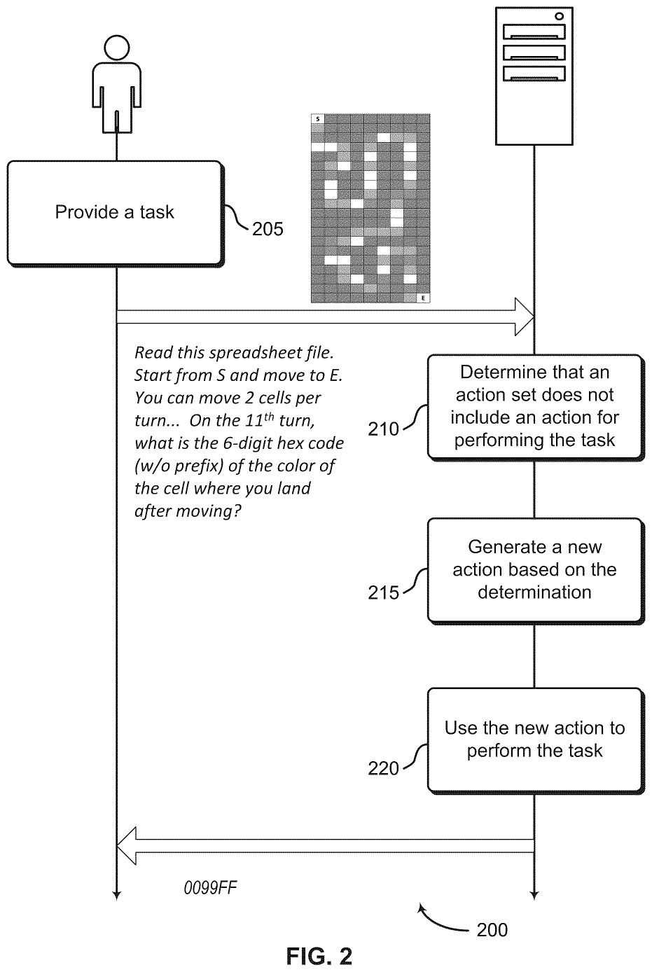

FIG. 2 shows an example of a method 200 for performing a task using a new action according to aspects of the present disclosure. Referring to FIG. 2, a data processing system (such as the data processing system 100 described with reference to FIG. 1) uses a machine learning agent to generate a new action (e.g., executable software code) that the machine learning agent determines will contribute to performing an assigned task. Because the machine learning agent is able to generate new actions, rather than merely selecting from predefined actions, the data processing system is able to perform actions to successfully perform tasks that conventional agent systems cannot.

At operation 205, a user provides a task. In some cases, the operations of this step refer to, or may be performed by, a user as described with reference to FIG. 1. In some embodiments, the user provides the task via a user interface provided by the data processing system. The task may include a text instruction and may also include other media, such as a video, an image, audio, additional text, a document, a hyperlink, etc. In the example of FIG. 2, the task includes a spreadsheet including colored cells and an instruction to provide a color of a cell that is landed upon based on an instructed movement pattern.

At operation 210, the system determines that an action set does not include an action for performing the task. In some cases, the operations of this step refer to, or may be performed by, a data processing apparatus as described with reference to FIGS. 1, 15, and 16. In an example, the machine learning agent generates an action plan based on the task, and optionally based on past actions and observations. In generating the action plan, the machine learning agent predicts that an action included in the action set is not applicable at a current step of performing the task, and determines that a new action that is applicable to the current step should be generated.

At operation 215, the system generates a new action based on the determination. In some cases, the operations of this step refer to, or may be performed by, a data processing apparatus as described with reference to FIGS. 1, 15, and 16. In an example, the machine learning agent generates an action based on the action plan, and optionally the task, previous actions, previous observations, or a combination thereof. The action includes executable software code.

At operation 220, the system uses the new action to perform the task. In some cases, the operations of this step refer to, or may be performed by, a data processing apparatus as described with reference to FIGS. 1, 15, and 16. In an example, a software interpreter of the data processing apparatus executes the action. Executing the action may cause the data processing apparatus to interact with another system, the Internet, a database, a file included in the task, or a combination thereof. In the example of FIG. 2, the executed software code included in the new action causes the data processing apparatus to interact with the spreadsheet included in the task (for example, by identifying color values of cells of the spreadsheet).

The data processing apparatus provides a result of the execution of the action to the machine learning agent (e.g., an observation). Based on the observation, the machine learning agent predicts that sufficient information has been observed for generating a response to the task. The machine learning agent generates a text response including the sufficient information (the color code “00099FF”) and the data processing system provides the response to the user via the user interface.

FIG. 3 shows an example of a machine learning agent 305 framework 300 according to aspects of the present disclosure. In one aspect, framework 300 includes machine learning agent 305, software interpreter 310, action retriever 315, internet 320, operating system 325, action set 330, and task 345. Machine learning agent 305 is an example of, or includes aspects of, the corresponding element described with reference to FIGS. 1 and 16. Software interpreter 310 is an example of, or includes aspects of, the corresponding element described with reference to FIG. 1. Action set 330 is an example of, or includes aspects of, the corresponding element described with reference to FIG. 1. Task 345 is an example of, or includes aspects of, the corresponding element described with reference to FIGS. 1 and 7. In one aspect, action set 330 includes generated actions 335 and predefined actions 340.

Referring to FIG. 3, according to some aspects, the behavior of an agent π (e.g., machine learning agent 305) of a data processing system according to the present disclosure (such as the data processing system described with reference to FIG. 1) is modelled as a partially observable Markov decision process defined by the tuple ( [symbol] , [symbol] , [symbol] , [symbol] , T, Z), where [symbol] is a task space, [symbol] is an action space including a potentially infinite set of actions [symbol] * (e.g., action set 330), [symbol] is a state space; [symbol] is an observation space, T= [symbol] λ [symbol] *→ [symbol] ( [symbol] ) is a state transition function that maps a state-action pair to a probability distribution over subsequent states, and Z: [symbol] × [symbol] *→ [symbol] ( [symbol] ) is an observation function that maps a state-action pair to a probability distribution over observations.

Given a task u∈ [symbol] (e.g., task 345), the agent π starts in an initial state s₀∈ [symbol] . At each time step t, the agent π selects or proposes an action aₜ∈ [symbol] * that causes an environment ε to transition to a new state sₜ₊₁ according to a transition probability T(sₜ, aₜ). The agent π0 then receives an observation oₜ₊₁ ∈ [symbol] drawn from the distribution Z(sₜ₊₁, aₜ). This process repeats until the agent π reaches a terminal state s_{T} that satisfies the original task u.

Existing machine learning agents can only select from predefined actions in a comparative action set {a₁, . . . , aₙ}. By contrast, at each time step t, the agent π is allowed to propose any action aₜ∈ [symbol] * to solve the task u, or to select a predefined action. The cumulative action set at time t is defined as [symbol] ₜ={a₁, a₂, . . . , aₜ}. Each new action aₜ may be an entirely novel action or a composition of previously generated actions from [symbol] ₜ₋₁. Consequently, the overall action space A evolves dynamically as the agent π encounters more tasks in [symbol] .

Accordingly, the agent π initializes with the task u and a predefined action set [symbol] (e.g., predefined actions 340) with [symbol] ∈ [symbol] . At time step t, the agent π samples a thought-action pair (hₜ, aₜ)~π_{θ}(aₜ| [symbol] , u, cₜ₋₁), where cₜ₋₁={(h₁, a₁, o₁), . . . , (hₜ₋₁, aₜ₋₁, oₜ₋₁)} represents the interaction history between the agent π and the environment & (e.g., software interpreter 310) up to time t−1. The thought hₜ is an action plan as described herein, where the action plan describes includes a proposal for the action aₜ and may include a basis for the proposal. The action aₜ includes software code. In some embodiments, the action aₜ includes a software function.

In some embodiments, the agent π samples the thought hₜ by generating the thought hₜ. In some embodiments, the agent π samples the action aₜ by generating the action aₜ. In some embodiments, the predefined action set [symbol] comprises actions defined prior to an initial step t=1 and the generated action set [symbol] ^{g} (e.g., generated actions 335) comprises actions generated during or following the initial time step. In some embodiments, the predefined action set [symbol] comprises human-defined actions and the generated action set [symbol] ^{g} comprises actions generated by machine learning agent 305.

Software interpreter 310 executes the action aₜ to interact with an external function or system (such as action retriever 315, Internet 320, operating system 325, the database 130 described with reference to FIG. 1, etc.) and returns an observation oₜ to the agent π, updating the context to cₜ=cₜ₋₁∪{(h₁, a₁, o₁)}. In some examples, software interpreter 310 includes a programming-language specific backend, such as a kernel, that is designed for interactivity between the software interpreter and the external function or system, and the software interpreter interacts with the external function or system via the backend.

If the action aₜ includes a new function that is not included in

$${𝒜}_{t - 1}^{g}$$

(e.g., previous generated actions of generated actions 335) or the predefined actions [symbol] , a data processing apparatus of the data processing system updates the generated action set by sewing

$${𝒜}_{t}^{g} = {𝒜}_{t - 1}^{g} ⋃ f ( {a}_{t} ) ,$$

where f(aₜ) denotes the set of functions defined in the action aₜ. In some embodiments, an ordering in which tasks are presented to the agent π forms a curriculum that influences the growth of [symbol] ^{g} (e.g., generated actions 335). Consequently, the performance of the agent π on a task uₜ may be influenced by previous tasks due to the accumulation.

In some embodiments, in response to receiving a task, the data processing system provides a prompt to machine learning agent 305, where the prompt includes guidelines for performing the task. An example prompt is described with reference to FIGS. 4 and 5. In some embodiments, action set 330 is included in the prompt.

In some embodiments, the data processing system includes predefined actions [symbol] in the prompt and provides the agent π access to the generated action set [symbol] ^{g} using an action retrieval function [symbol] : [symbol] × [symbol] → [symbol] (e.g., action retriever 315), where [symbol] denotes the space of queries and [symbol] is the set of positive integers, and the generated action set [symbol] ^{g} is stored in a database (such as the database 130 described with reference to FIG. 1). The prompt includes an instruction to the agent π to provide a one-line text string describing a purpose of a function included in a generated action.

The retrieval function [symbol] (q, k) embeds the text string in an embedding space (e.g., a vector representation space), for example, using an encoder comprising an ANN configured to generate an embedding of an input in an embedding space, or comprising an embedding algorithm, such as an embedding matrix, to form an index of the generated action (and therefore indices of generated actions). Given a query q∈ [symbol] and an integer k∈ [symbol] , where the query comprises an action plan, the retrieval function [symbol] (q, k) embeds the query to obtain a query embedding in a same embedding space as the embedding of the text string.

The retrieval function [symbol] (q, k) computes a cosine similarity between the query embedding and the embedding of the text string and returns top-k corresponding actions included in the generated action set [symbol] ^{g} and including the text strings based on the comparison. In some embodiments, the retrieval function [symbol] (q, k) is included in the predefined action set [symbol] to enable the agent π to decide when to invoke action retrieval. Therefore, the agent π is able to autonomously decide to perform action retrieval by selecting the retrieval function [symbol] (q, k) during the decision-making process of the agent π. By omitting the generated action set [symbol] ^{g} from the prompt and using the retrieval function [symbol] (q, k) to retrieve a generated action, the data processing system avoids exceeding a context limit of the agent π for parsing the prompt.

FIG. 4 shows an example of first portion of a machine learning agent prompt 400 and FIG. 5 shows an example of a second portion of the machine learning agent prompt 400 of FIG. 4. Referring to FIGS. 4 and 5, according to some aspects, a data processing apparatus (such as the data processing apparatus 105 described with reference to FIG. 1) provides a prompt to a machine learning agent (such as the machine learning agent 115 described with reference to FIG. 1), where the prompt includes guidelines for generating software code. The data processing apparatus may provide the prompt to the machine learning agent in response to receiving a task. The data processing apparatus may provide the prompt to the machine learning agent prior to receiving a task to initialize the machine learning agent.

In the example of FIG. 4, the data processing apparatus initializes the machine learning agent using prompt 400 prior to receiving a task. Prompt 400 includes an instruction to generate a thought (e.g., an action plan) and code (e.g., an action) to solve a given task. Prompt 400 includes instructions to retrieve or generate code that implements a plan for solving the task provided in the thought. Prompt 400 includes an instruction to implement actions based on returned results from an interpreter (e.g., observations). Prompt 400 includes an instruction to continue to implement actions until a solution to the task is found or a maximum number of iterations is performed. Prompt 400 includes instructions for formatting the thought and the code.

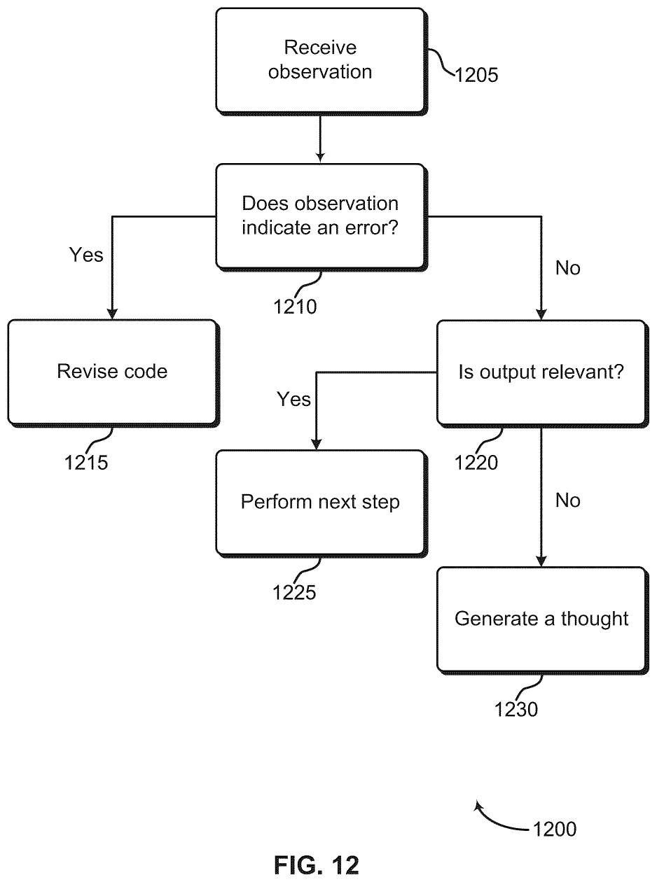

As shown in FIG. 5, prompt 400 includes instructions to use a get_relevant_tools function to retrieve an additional function. Prompt 400 includes guidelines for writing code. Prompt 400 includes guidelines for a two-step process analyzing a result from an interpreter. The two-step process is described in further detail with reference to FIG. 12.

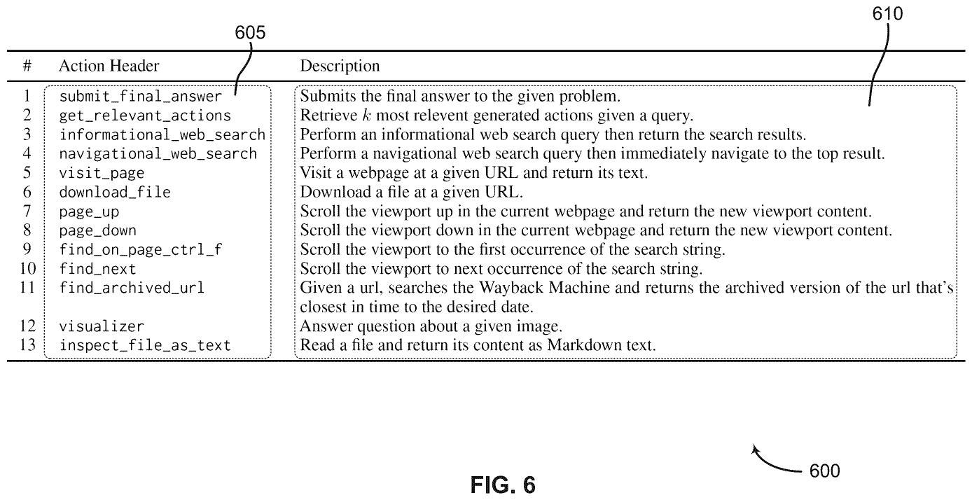

FIG. 6 shows an example of a table 600 of a set of functions according to aspects of the present disclosure. Referring to FIG. 6, set of functions 605 listed in table 600 includes example functions that have been predefined or generated by a machine learning agent (such as the machine learning agent 115 described with reference to FIG. 1). The machine learning agent may retrieve or generate an action that includes one or more functions of the set of functions 605, as described with reference to FIG. 3. Descriptions 610 describe the corresponding functions.

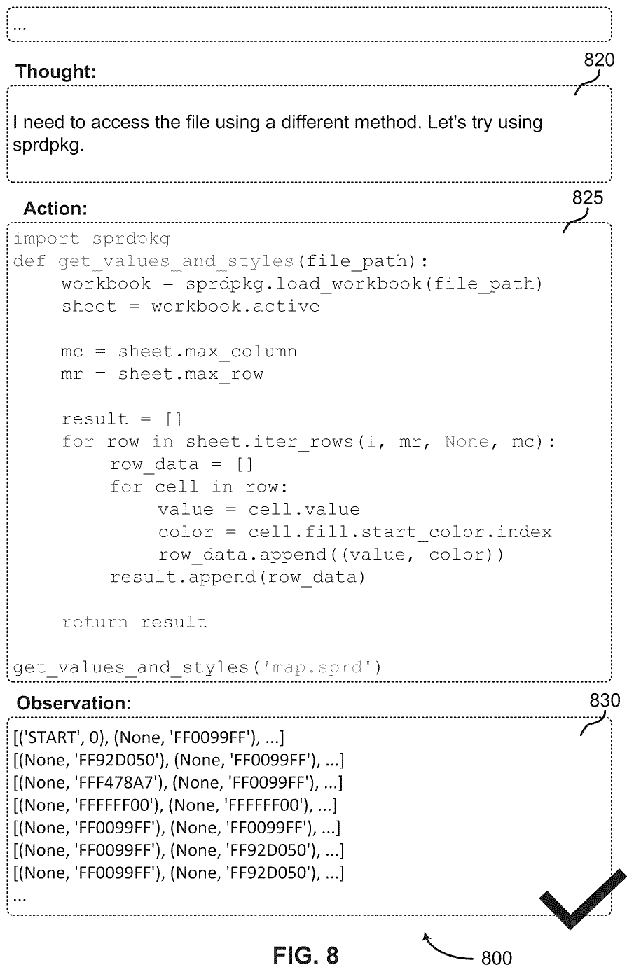

FIG. 7 shows an example 700 of an unsuccessful execution of a predefined action according to aspects of the present disclosure. The example shown includes list of functions 705, task 710, spreadsheet 715, first thought 720, predefined action 725, and first observation 730. Task 710 is an example of, or includes aspects of, the corresponding element described with reference to FIGS. 1 and 3. FIG. 8 shows an example 800 of a successful execution of a new action according to aspects of the present disclosure. The example shown includes second thought 805, new action 810, and second observation 815.

Referring to FIGS. 7 and 8, a machine learning agent (such as the machine learning agent 115 described with reference to FIG. 1) is initialized via a prompt (such as the prompt 400 described with reference to FIGS. 4 and 5) that includes list of functions 705 to perform a task. Task 710 includes a spreadsheet file “map.sprd” (spreadsheet 715) and the text, “Read this spreadsheet file. Start from S and move to E. You can move 2 cells per turn, and you may move up, down, left, or right. You can't move fewer than 2 cells, and you can't move backward. You can't move onto any blue cells. On the 11th turn, what is the 6-digit hex code (w/o prefix) of the color of the cell where you land after moving?”

The machine learning agent generates first thought 720 based on the prompt and task 710. First thought 720 includes the text, “First, I need to inspect the spreadsheet file to understand the layout, including the positions of S, E, and blue cells.” Based on first thought 720, the machine learning agent retrieves predefined action 725 by providing an argument, “map.sprd.”, for the predefined inspect_file function included in list of functions 705 based on task 710 and first thought 720. The machine learning agent provides predefined action 725 to a software interpreter (such as the software interpreter 120 described with reference to FIG. 1) to be executed.

The software interpreter executes predefined action 725 and returns a result of performing the inspect_file function on spreadsheet 715 (first observation 730) to the machine learning agent. However, when reading spreadsheet files, the inspect_file function does not account for formatting properties such as cell color, leading to incomplete information being returned and preventing the machine learning agent from solving the task. The machine learning agent parses first observation 730 to understand that first observation 730 includes a set of “not a number” (NaN) values instead of an expected result of predefined action 725, and that first observation 730 therefore indicates an error.

Referring to FIG. 8, the machine learning agent generates second thought 820 based on first observation 730, first thought 720, predefined action 725, task 710, and list of functions 705. Second thought 820 includes the text, “I need to access the file using a different method. Let's try using sprdpkg.” Second thought 820 therefore indicates a realization that predefined action 725 was unsuccessful, that the action set is inadequate because it does not include a function that is sufficient for obtaining currently required information for performing task 710, and that a new function including a use of the library sprdpkg should be defined.

The machine learning agent generates new action 825 based on second thought 820, first observation 730, first thought 720, predefined action 725, and task 710. New action 825 includes code indicating that the sprdpkg is to be imported, code defining a new function get_values_and_styles, and code indicating that the new function get_values_and_styles should be executed using spreadsheet 715 as an argument.

The software interpreter executes new action 825 and returns observation 830 to the machine learning agent based on the execution. The observation includes color codes for the cells of spreadsheet 715, and therefore provides information that the machine learning agent will use to successfully perform the task. The machine learning agent then generates a new thought based on observation 830, and proceeds until the task is completed or a maximum number of iterations of a thought-action sampling process are performed. As shown in FIG. 1, the machine learning agent eventually generates a response 0099FF to complete the task.

Accordingly, the ability to generate new actions allows the machine learning model to complete tasks that existing agents that are restricted to retrieving pre-defined actions are unable to complete (for example, due to becoming stuck in a loop of generating actions including inadequate predefined functions, such as the inspect_file function in this case, until a maximum number of iterations is reached).

FIG. 9 shows an example of a transformer 900 according to aspects of the present disclosure. The example shown includes encoder 905, decoder 920, input 940, input embedding 945, input positional encoding 950, previous output 955, previous output embedding 960, previous output positional encoding 965, and output 970. According to some aspects, transformer 900 comprises architectural elements of the machine learning agent described with reference to FIGS. 1, 3, and 16.

According to some aspects, a transformer comprises one or more ANNs comprising attention mechanisms that enable the transformer to weigh an importance of different words or tokens within a sequence. In some examples, a transformer processes entire sequences simultaneously in parallel using multiple attention heads, making the transformer highly efficient and allowing the transformer to capture long-range dependencies more effectively.

According to some aspects, a transformer comprises an encoder-decoder structure. The encoder of the transformer processes an input sequence and encodes the input sequence into a set of high-dimensional representations. The decoder of the transformer generates an output sequence based on the encoded representations and previously generated tokens. The encoder and the decoder each include one or more layers of self-attention mechanisms and feed-forward ANNs.

The self-attention mechanism allows the transformer to focus on different parts of an input sequence while computing representations for the input sequence. The self-attention mechanism captures relationships between words of a sequence by assigning attention weights to each word based on a relevance to other words in the sequence, thereby enabling the transformer to model dependencies regardless of a distance between words.

An attention mechanism is a key component in some ANN architectures that enables an ANN to selectively focus on different parts of an input sequence, assigning varying degrees of importance or attention to each part. The attention mechanism achieves the selective focus by considering a relevance of each input element with respect to a current state of the ANN.

According to some aspects, an ANN employing an attention mechanism receives an input sequence and maintains the current state, which represents an understanding or context. For each element in the input sequence, the attention mechanism computes an attention score that indicates the importance or relevance of that element given the current state. The attention scores are transformed into attention weights through a normalization process, such as applying a softmax function. The attention weights represent the contribution of each input element to the overall attention. The attention weights are used to compute a weighted sum of the input elements, resulting in a context vector. The context vector represents the attended information or the part of the input sequence that the ANN considers most relevant for the current step. The context vector is combined with the current state of the ANN, providing additional information and influencing subsequent predictions or decisions of the ANN.

By incorporating an attention mechanism, an ANN dynamically allocates attention to different parts of the input sequence, allowing the ANN to focus on relevant information and capture dependencies across longer distances.

Encoder 905 includes multi-head self-attention sublayer 910 and feed-forward network sublayer 915. Decoder 920 includes first multi-head self-attention sublayer 925, second multi-head self-attention sublayer 930, and feed-forward network sublayer 935.

Encoder 905 is configured to map input 940 (for example, a prompt, a task, an observation, and/or an action plan) to a sequence of continuous representations that are fed into decoder 920. Decoder 920 generates output 970 (e.g., a prediction of an output sequence of words or tokens) based on the output of encoder 905 and previous output 955 (e.g., a previously predicted output sequence), which allows for the use of autoregression.

For example, encoder 905 parses input 940 into tokens and vectorizes the parsed tokens to obtain input embedding 945, and adds input positional encoding 950 (e.g., positional encoding vectors for input 940 of a same dimension as input embedding 945) to input embedding 945. Input positional encoding 950 includes information about relative positions of words or tokens in input 940.

Encoder 905 comprises one or more encoding layers that generate contextualized token representations, where each representation corresponds to a token that combines information from other input tokens via self-attention mechanism. Each encoding layer of encoder 905 comprises a multi-head self-attention sublayer (e.g., multi-head self-attention sublayer 910). The multi-head self-attention sublayer implements a multi-head self-attention mechanism that receives different linearly projected versions of queries, keys, and values to produce outputs in parallel at each attention head of transformer 900. Each encoding layer of encoder 905 also includes a fully connected feed-forward network sublayer (e.g., feed-forward network sublayer 915) comprising two linear transformations surrounding a Rectified Linear Unit (ReLU) activation:

FFN(x)=ReLU(W₁x+b₁)W₂+b₂ (1)

Each layer employs different weight parameters (W₁, W₂) and different bias parameters (b₁, b₂) to apply a same linear transformation to each word or token in input 940.

Each sublayer of encoder 905 is followed by a normalization layer that normalizes a sum computed between a sublayer input x and an output sublayer (x) generated by the sublayer:

layernorm(x+sublayer(x)) (2)

Encoder 905 is bidirectional because encoder 905 attends to each word or token in input 940 regardless of a position of the word or token in input 940. Decoder 920 comprises one or more decoding layers (e.g., six decoding layers). Each decoding layer comprises three sublayers including a first multi-head self-attention sublayer (e.g., first multi-head self-attention sublayer 925), a second multi-head self-attention sublayer (e.g., second multi-head self-attention sublayer 930), and a feed-forward network sublayer (e.g., feed-forward network sublayer 935). Each sublayer of decoder 920 is followed by a normalization layer that normalizes a sum computed between a sublayer input x and an output sublayer (x) generated by the sublayer.

Decoder 920 generates previous output embedding 960 of previous output 955 and adds previous output positional encoding 965 (e.g., position information for words or tokens in previous output 955) to previous output embedding 960. Each first multi-head self-attention sublayer receives the combination of previous output embedding 960 and previous output positional encoding 965 and applies a multi-head self-attention mechanism to the combination. For each word in an input sequence, each first multi-head self-attention sublayer of decoder 920 attends only to words preceding the word in the sequence, and so a prediction of transformer 900 for a word at a particular position only depends on known outputs for a word that came before the word in the sequence. In some cases, each first multi-head self-attention sublayer implements multiple single-attention functions in parallel by introducing a mask over values produced by the scaled multiplication of matrices Q and K by suppressing matrix values that would otherwise correspond to disallowed connections.

Each second multi-head self-attention sublayer implements a multi-head self-attention mechanism similar to the multi-head self-attention mechanism implemented in each multi-head self-attention sublayer of encoder 905 by receiving a query Q from a previous sublayer of decoder 920 and a key K and a value V from the output of encoder 905, allowing decoder 920 to attend to each word in the input 940. Each feed-forward network sublayer implements a fully connected feed-forward network similar to feed-forward network sublayer 915. The feed-forward network sublayers are followed by a linear transformation and a softmax to generate a prediction of output 970.

### Task Performance

FIG. 10 shows an example of a method 1000 for generating and executing a new action to perform a task according to aspects of the present disclosure. Referring to FIG. 10, a data processing system (such as the data processing system 100 described with reference to FIG. 1) performs method 1000 to use a machine learning agent to generate a new action (e.g., executable software code) that the machine learning agent determines will contribute to performing an assigned task. Because the machine learning agent is able to generate new actions, rather than merely selecting from predefined actions, the data processing system is able to perform actions to successfully perform tasks that conventional agent systems cannot.

At operation 1005, the system receives a task. In some cases, the operations of this step refer to, or may be performed by, a data processing apparatus as described with reference to FIGS. 1, 15, and 16. In an example, a user provides the task to the data processing apparatus via a user interface as described with reference to FIG. 1. In some embodiments, the task includes text defining the task. In some embodiments, the task includes a document, such as a text file, an audio file, an image file, a video file, a multi-media file, or other information such as a hyperlink to a website or a file, etc.

At operation 1010, the system determines, using a machine learning agent, that an action set of the machine learning agent is inadequate for performing the task. In some cases, the operations of this step refer to, or may be performed by, a machine learning agent as described with reference to FIGS. 1, 3, and 16. According to some aspects, the machine learning agent determines that the action set is inadequate as described with reference to FIG. 3.

For example, in some embodiments, the machine learning agent generates an action plan for performing a sub-task relating to the task, and the machine learning agent makes the determination based on the action plan. In some examples, the machine learning agent determines, while generating the action plan, that the action plan requires the new action and that the required new action is absent from the action set. In some examples, a software interpreter (such as the software interpreter 120 described with reference to FIG. 1) performs an action to obtain a result, and the machine learning agent determines based on the result that the performed action was inadequate for performing the task.

At operation 1015, the system generates, using the machine learning agent, a new action for the action set, where the new action includes software code for performing the task. In some cases, the operations of this step refer to, or may be performed by, a machine learning agent as described with reference to FIGS. 1, 3, and 16. According to some aspects, the machine learning agent generates the new action as described with reference to FIG. 3. In some embodiments, generating the new action comprises generating code that includes a definition of a function that is not defined in the action set.

At operation 1020, the system executes the new action to perform the task. In some cases, the operations of this step refer to, or may be performed by, a software interpreter as described with reference to FIG. 1. According to some aspects, the software interpreter executes the action as described with reference to FIG. 3.

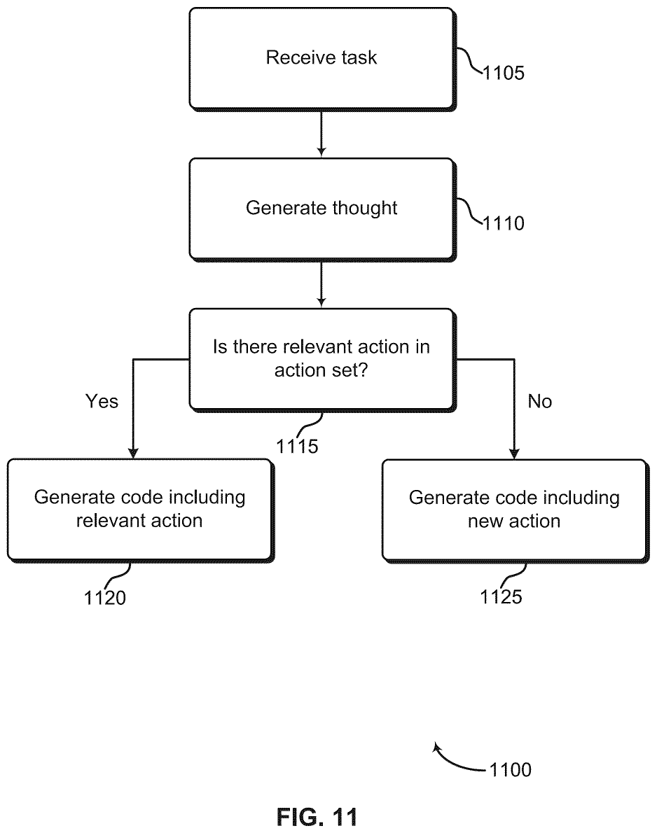

FIG. 11 shows an example of a flow diagram depicting a procedure 1100 for performing a task according to aspects of the present disclosure. The procedure may be performed by a machine learning agent according to aspects of the present disclosure, such as the machine learning agent 115 described with reference to FIG. 1.

At step 1105, the machine learning agent receives a task. At step 1110, the machine learning agent generates a thought. At step 1115, if there is a relevant action in action set, the machine leaning agent generates code including the relevant action aₜ step 1120. If there is not a relevant action in the action set, the machine learning agent generates code including a new action aₜ step 1125.

FIG. 12 shows an example of a flow diagram depicting a procedure 1200 for evaluating an observation according to aspects of the present disclosure. The procedure may be performed by a machine learning agent according to aspects of the present disclosure, such as the machine learning agent 115 described with reference to FIG. 1.

At step 1205, the machine learning agent receives an observation from a software interpreter (e.g., the software interpreter 120 described with reference to FIG. 1). At step 1210, if the observation indicates an error, the machine learning agent revises the generated code at step 1215. If the observation does not indicate an error, the machine learning agent determines if the output of the executed code is relevant to performing the task at step 1220. If the output of the executed code is relevant, the machine learning agent performs a next step at step 1225. If the output of the executed code is irrelevant, the machine learning system generates a new thought about how to perform the current step at step 1230.

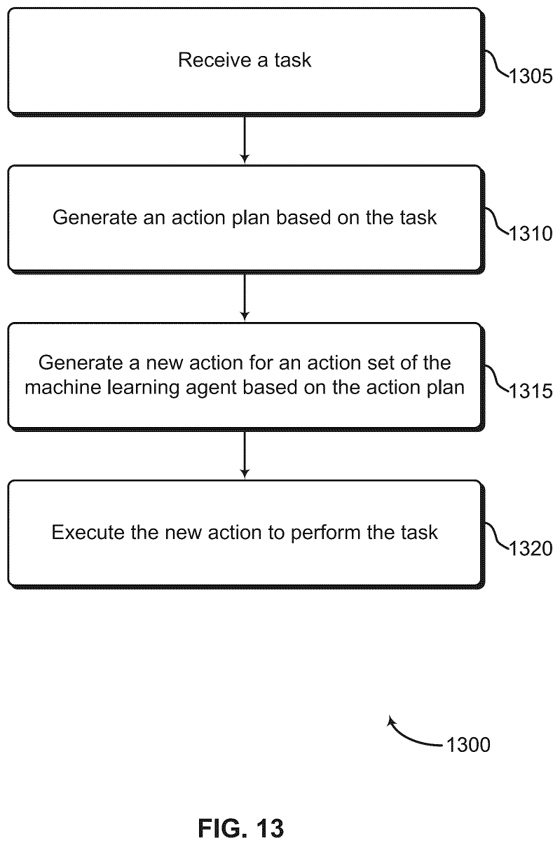

FIG. 13 shows an example of a method 1300 for executing a new action generated based on an action plan according to aspects of the present disclosure. At operation 1305, the system receives a task. In some cases, the operations of this step refer to, or may be performed by, a data processing apparatus as described with reference to FIGS. 1, 15, and 16. In an example, a user provides the task to the data processing apparatus via a user interface as described with reference to FIG. 1. In some embodiments, the task includes text defining the task.

At operation 1310, the system generates, using a machine learning agent, an action plan based on the task. In some cases, the operations of this step refer to, or may be performed by, a machine learning agent as described with reference to FIGS. 1, 3, and 16. According to some aspects, the machine learning agent generates the action plan as described with reference to FIG. 3.

At operation 1315, the system generates, using the machine learning agent, a new action for an action set of the machine learning agent based on the action plan. In some cases, the operations of this step refer to, or may be performed by, a machine learning agent as described with reference to FIGS. 1, 3, and 16. According to some aspects, the machine learning agent generates the new action based on the action plan as described with reference to FIG. 3.

At operation 1320, the system executes the new action to perform the task. In some cases, the operations of this step refer to, or may be performed by, a software interpreter as described with reference to FIG. 1. According to some aspects, the executes the new action as described with reference to FIG. 3.

Accordingly, a method for data processing is described. One or more aspects of the method include receiving a task; determining, using a machine learning agent, that an action set of the machine learning agent is inadequate for performing the task; generating, using the machine learning agent, a new action for the action set, wherein the new action comprises software code for performing the task; and executing the new action to perform the task.

In some examples, determining that the action set of the machine learning agent is inadequate for performing the task includes generating an action plan, wherein the determination is made based on the action plan. Some examples of the method further include determining that the action plan requires the new action and that the new action is absent from the action set.

In some examples, determining that the action set of the machine learning agent is inadequate for performing the task includes performing an action from the action set to obtain a result. Some examples further include determining that the result is inadequate for performing the task. Some examples of the method further include determining that the new action executed successfully. Some examples further include adding the new action to the action set.

Some examples of the method further include retrieving an additional action from an external source. Some examples further include adding the additional action to the action set. Some examples of the method further include retrieving the additional action based on a similarity score.

Some examples of the method further include receiving an error message in response to executing the new action. Some examples further include modifying the new action based on the error message. Some examples of the method further include iteratively evaluating the output of the new action and modifying the new action based on the output. Some examples of the method further include providing a prompt to the machine learning agent, wherein the prompt includes guidelines for generating the software code.

Furthermore, a method for data processing is described. One or more aspects of the method include receiving a task; generating, using a machine learning agent, an action plan based on the task; generating, using the machine learning agent, a new action for an action set of the machine learning agent based on the action plan; and executing the new action to perform the task.

Some examples of the method further include determining that the action set of the machine learning agent is inadequate for performing the task based on the action plan. Some examples of the method further include determining that the action plan requires the new action and that the new action is absent from the action set. Some examples of the method further include determining that the action executed successfully. Some examples further include adding the new action to the action set.

Some examples of the method further include performing an action from the action set to obtain a result. Some examples further include determining that the result is inadequate for performing the task. Some examples of the method further include retrieving an additional action from an external source. Some examples further include adding the additional action to the action set. Some examples of the method further include providing a prompt to the machine learning agent, wherein the prompt includes guidelines for generating software code for performing the task.

In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

### Training

FIG. 14 shows an example of a flow diagram depicting an algorithm as a step-by-step procedure 1400 for training a machine learning model according to aspects of the present disclosure. In some embodiments, the procedure 1400 describes an operation of the training component 1625 described for configuring the machine learning agent 1615 as described with reference to FIG. 16. The procedure 1400 provides one or more examples of generating training data, use of the training data to train a machine learning model, and use of the trained machine learning model to perform a task.

To begin in this example, a machine learning system collects training data (block 1402) that is to be used as a basis to train a machine learning model, i.e., which defines what is being modeled. The training data is collectable by the machine learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine learning system is also configurable to identify features that are relevant (block 1404) to a type of task, for which the machine learning model is to be trained. Task examples include classification, natural language processing, generative artificial intelligence, recommendation engines, reinforcement learning, clustering, and so forth. To do so, the machine learning system collects the training data based on the identified features and/or filters the training data based on the identified features after collection. The training data is then utilized to train a machine learning model.

In order to train the machine learning model in the illustrated example, the machine learning model is first initialized (block 1406). Initialization of the machine learning model includes selecting a model architecture (block 1408) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1410). The loss function is utilized to measure a difference between an output of the machine learning model (i.e., predictions) and target values (e.g., as expressed by the training data) to be used to train the machine learning model. Additionally, an optimization algorithm is selected (1412) that is to be used in conjunction with the loss function to optimize parameters of the machine learning model during training, examples of which include gradient descent, stochastic gradient descent (SGD), and so forth.

Initialization of the machine learning model further includes setting initial values of the machine learning model (block 1414) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine learning model is then trained using the training data (block 1418) by the machine learning system. A machine learning model refers to a computer representation that can be tuned (e.g., trained and retrained) based on inputs of the training data to approximate unknown functions. In particular, the term machine learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine learning model to perform an associated task.

As part of training the machine learning model, a determination is made as to whether a stopping criterion is met (decision block 1420), i.e., which is used to validate the machine learning model. The stopping criterion is usable to reduce overfitting of the machine learning model, reduce computational resource consumption, and promote an ability of the machine learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1420), the procedure 1400 continues training of the machine learning model using the training data (block 1418) in this example.

If the stopping criterion is met (“yes” from decision block 1420), the trained machine learning model is then utilized to generate an output based on subsequent data (block 1422). The trained machine learning model, for instance, is trained to perform a task as described above and therefore once trained is configured to perform that task based on subsequent data received as an input and processed by the machine learning model.

A data processing system according to aspects of the present disclosure outperforms existing large language model (LLM) agents on a benchmark that stress-tests capabilities of generalist agents across a wide range of tasks without imposing constraints on how an agent must interact with an environment. Accordingly, the data processing system demonstrates that an ability to perform arbitrary actions (and in some cases in combination with an accumulation of more actions over time) offers significant increase in task completion ability over traditional LLM agent pipelines having fixed, predefined action sets, especially in highly complex, long-horizon problems.

### Data Processing Apparatus

FIG. 15 shows an example of a computing device according to aspects of the present disclosure. Computing device 1500 is an example of, or includes aspects of, the data processing apparatus described with reference to FIGS. 1 and 16. In one aspect, computing device 1500 includes processor(s) 1505, memory subsystem 1510, communication interface 1515, I/O interface 1520, user interface component(s) 1525, and channel 1530. In some embodiments, computing device 1500 includes one or more processors 1505 that can execute instructions stored in memory subsystem 1510.

According to some aspects, computing device 1500 includes one or more processors 1505. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1510 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1515 operates at a boundary between communicating entities (such as computing device 1500, one or more user devices, a cloud, and one or more databases) and channel 1530 and can record and process communications. In some cases, communication interface 1515 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1520 is controlled by an I/O controller to manage input and output signals for computing device 1500. In some cases, I/O interface 1520 manages peripherals not integrated into computing device 1500. In some cases, I/O interface 1520 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1520 or via hardware components controlled by the I/O controller.

According to some aspects, user interface component(s) 1525 enable a user to interact with computing device 1500. In some cases, user interface component(s) 1525 include an audio device, such as an external speaker system, an external display device such as a display screen, an input device (e.g., a remote-control device interfaced with a user interface directly or through the I/O controller), or a combination thereof. In some cases, user interface component(s) 1525 include a GUI.

FIG. 16 shows an example of a data processing apparatus 1600 according to aspects of the present disclosure. Data processing apparatus 1600 is an example of, or includes aspects of, the corresponding element described with reference to FIGS. 1 and 16. In some embodiments, data processing apparatus 1600 includes processor unit 1605, memory unit 1610, machine learning agent 1615, I/O module 1620, and training component 1625. Training component 1625 updates parameters of the machine learning agent 1615 stored in memory unit 1610. In some examples, the training component 1625 is located outside the data processing apparatus 1600.

Processor unit 1605 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 1605 is configured to operate a memory array using a memory controller. In other cases, a memory controller is integrated into processor unit 1605. In some cases, processor unit 1605 is configured to execute computer-readable instructions stored in memory unit 1610 to perform various functions. In some aspects, processor unit 1605 includes special purpose components for modem processing, baseband processing, digital signal processing, or transmission processing. According to some aspects, processor unit 1605 comprises one or more processors 1505 described with reference to FIG. 15.

Memory unit 1610 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1605 to perform various functions described herein.

In some cases, memory unit 1610 includes a basic input/output system (BIOS) that controls basic hardware or software operations, such as an interaction with peripheral components or devices. In some cases, memory unit 1610 includes a memory controller that operates memory cells of memory unit 1610. For example, the memory controller may include a row decoder, column decoder, or both. In some cases, memory cells within memory unit 1610 store information in the form of a logical state. According to some aspects, memory unit 1610 is an example of the memory subsystem 1510 described with reference to FIG. 15.

According to some aspects, data processing apparatus 1600 uses one or more processors of processor unit 1605 to execute instructions stored in memory unit 1610 to perform functions described herein. For example, the data processing apparatus 1600 may perform operations comprising receiving a task; determining, using a machine learning agent, that an action set of the machine learning agent is inadequate for performing the task; generating, using the machine learning agent, a new action for the action set, wherein the new action comprises software code for performing the task; and executing the new action to perform the task.

The memory unit 1610 may include a machine learning agent 1615. According to some aspects, machine learning agent 1615 comprises machine learning parameters stored in memory unit 1610. Machine learning agent 1615 is an example of, or includes aspects of, the corresponding element described with reference to FIGS. 1 and 3.

In some embodiments, the machine learning agent 1615 is an artificial neural network (ANN). An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of the machine learning agent 1615 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 1625 may train the machine learning agent 1615. For example, parameters of the machine learning agent 1615 can be learned or estimated from training data and then used to make predictions or perform tasks based on learned patterns and relationships in the data. In some examples, the parameters are adjusted during the training process to minimize a loss function or maximize a performance metric (e.g., as described with reference to FIG. 14). The goal of the training process may be to find optimal values for the parameters that allow the machine learning agent 1615 to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning agent 1615 can be used to make predictions on new, unseen data (i.e., during inference).

I/O module 1620 receives inputs from and transmits outputs of the data processing apparatus 1600 to other devices or users. For example, I/O module 1620 receives inputs for the machine learning agent 1615 and transmits outputs of the machine learning agent 1615. According to some aspects, I/O module 1620 is an example of the I/O interface 1520 described with reference to FIG. 15.

According to some aspects, training component 1625 comprises executable code (e.g., software) stored in memory unit 1610, firmware, one or more hardware circuits, or a combination thereof.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application-specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method for data processing, comprising:
receiving a task;
determining, using a machine learning agent, that an action set of the machine learning agent is inadequate for performing the task;
generating, using the machine learning agent, a new action for the action set, wherein the new action comprises software code for performing the task; and
executing the new action to perform the task.

2. The method of claim 1, wherein determining that the action set of the machine learning agent is inadequate for performing the task comprises:
generating an action plan, wherein the determination is made based on the action plan.

3. The method of claim 2, further comprising:
determining that the action plan requires the new action and that the new action is absent from the action set.

4. The method of claim 1, wherein determining that the action set of the machine learning agent is inadequate for performing the task comprises:
performing an action from the action set to obtain a result; and
determining that the result is inadequate for performing the task.

5. The method of claim 1, further comprising:
determining that the new action executed successfully; and
adding the new action to the action set.

6. The method of claim 1, further comprising:
retrieving an additional action from an external source; and
adding the additional action to the action set.

7. The method of claim 6, further comprising:
retrieving the additional action based on a similarity score.

8. The method of claim 1, further comprising:
receiving an error message in response to executing the new action; and
modifying the new action based on the error message.

9. The method of claim 1, further comprising:
iteratively evaluating an output of the new action and modifying the new action based on the output.

10. The method of claim 1, wherein generating the new action comprises:
providing a prompt to the machine learning agent, wherein the prompt includes guidelines for generating the software code.

11. A non-transitory computer readable medium storing code for data processing, the code comprising instructions that, when executed by at least one processor, cause the at least one processor to perform operations comprising:
receiving a task;
generating, using a machine learning agent, an action plan based on the task;
generating, using the machine learning agent, a new action for an action set of the machine learning agent based on the action plan; and
executing the new action to perform the task.

12. The non-transitory computer readable medium of claim 11, the code further comprising instructions that, when executed by the at least one processor, cause the at least one processor to perform operations comprising:
determining that the action set of the machine learning agent is inadequate for performing the task based on the action plan.

13. The non-transitory computer readable medium of claim 11, the code further comprising instructions that, when executed by the at least one processor, cause the at least one processor to perform operations comprising:
determining that the action plan requires the new action and that the new action is absent from the action set.

14. The non-transitory computer readable medium of claim 11, the code further comprising instructions that, when executed by the at least one processor, cause the at least one processor to perform operations comprising:
determining that the action executed successfully; and
adding the new action to the action set.

15. The non-transitory computer readable medium of claim 11, the code further comprising instructions that, when executed by the at least one processor, cause the at least one processor to perform operations comprising:
performing an action from the action set to obtain a result; and
determining that the result is inadequate for performing the task.

16. The non-transitory computer readable medium of claim 11, the code further comprising instructions that, when executed by the at least one processor, cause the at least one processor to perform operations comprising:
retrieving an additional action from an external source; and
adding the additional action to the action set.

17. The non-transitory computer readable medium of claim 11, the code further comprising instructions that, when executed by the at least one processor, cause the at least one processor to perform operations comprising:
providing a prompt to the machine learning agent, wherein the prompt includes guidelines for generating software code for performing the task.

18. A system comprising:
a memory component; and
a processing device coupled to the memory component, the processing device configured to perform operations comprising:
receiving a task;
determining, using a machine learning agent, that an action set of the machine learning agent is inadequate for performing the task;
generating, using the machine learning agent, a new action for the action set, wherein the new action comprises software code for performing the task; and
executing the new action to perform the task.

19. The system of claim 18, further comprising:
a software interpreter configured to execute the new action.

20. The system of claim 18, further comprising:
a database storing an additional action.
